(19) United States
(12) Patent Application Publication
(10) Pub. No.: US 2025/0156990 A1
(43) Pub. Date: May 15, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: ATSUSHI ISHIHARA, TOKYO (JP); HIROYUKI AGA, TOKYO (JP)

(21) Appl. No.: 18/839,460

(22) PCT Filed: Jan. 16, 2023
(86) PCT No.: PCT/JP2023/000995

§ 371 Date: Aug. 19, 2024

(30) Foreign Application Priority Data
Feb. 28, 2022 (JP) 2022-030103

(51) Int. Cl. G06T 3/40; G06F 3/01; G06T 7/50; G06T 11/00

(52) U.S. Cl. CPC G06T 3/40; G06F 3/013; G06T 7/50; G06T 11/00; G06T 2207/20021

(57) ABSTRACT

An information processing device includes a processing time determination unit that determines a processing time for performing post-processing on a depth map on the basis of a position and a posture of a device and importance level information based on a display included in the device, and a post-processing unit that performs the post-processing on the depth map for the processing time determined by the processing time determination unit.

### TECHNICAL FIELD

The present technology relates to an information processing device, an information processing method, and a program.

### BACKGROUND ART

There is a function called video see through (VST) in a virtual reality (VR) device such as a head mounted display (HMD) including a camera. Usually, when the HMD is worn, the field of view is blocked by the display and the housing and a user cannot see the outside state, but by displaying an image of the outside world captured by the camera on a display 109 included in the HMD, the user can see the outside state while the HMD is worn.

In such a VR HMD or AR device (hereinafter, it is described as an HMD for XR.), it is necessary to acquire a surrounding environment, particularly a depth map which is distance measurement data, more accurately within a certain period of time with a low delay. At the time of viewing the VR content, it is necessary not only in terms of safety that the virtual object does not collide with a real object hidden by the content, but also in order to correctly express the anteroposterior relationship between the virtual object and the real object.

The resolution of the HMD for XR is increasing year by year, and in order to create a high definition video in which virtual and reality are fused, a depth map (distance measurement data) used for shielding is also required to have no loss due to a distance measurement failure and to have high resolution. As the lack of distance measurement failure is filled or the depth map is upsampled to increase the resolution, a correct shielding mask can be obtained even for a fine portion, but the processing amount increases. As the processing amount increases, the processing time increases, leading to a display delay or an increase in heat generation and power consumption.

Accordingly, a method of changing the resolution and the frame rate of the sensor on the basis of the gaze area of the user has been proposed (Patent Document 1). Thus, not only the load on the drawing side but also the sensing side can reduce the sensing load in a case where the contribution in the final display content is small.

### CITATION LIST

### Patent Document

Patent Document 1: Japanese Patent Application Laid-Open No. 2017-174125

### SUMMARY OF THE INVENTION

### Problems to be Solved by the Invention

However, in order to present a stable display result in the HMD for XR, not only drawing processing but also subsequent depth map generation from sensing such as distance measurement, post-processing for increasing the resolution of the depth map, and the like are required to be performed within a certain time and with low delay, but this point is not taken into consideration in the technology described in Patent Document 1.

The present technology has been made in view of such a problem, and an object thereof is to provide an information processing device, an information processing method, and a program capable of generating a high-resolution depth map without delaying processing.

### Solutions to Problems

In order to solve the above-described problem, a first technology is an information processing device including a processing time determination unit that determines a processing time for performing post-processing on a depth map on the basis of a position and a posture of a device and importance level information based on a display included in the device, and a post-processing unit that performs the post-processing on the depth map for the processing time determined by the processing time determination unit.

Furthermore, a second technology is an information processing method including determining a processing time for performing post-processing on a depth map on the basis of a position and a posture of a device and importance level information based on a display included in the device, and performing the post-processing on the depth map for the processing time determined.

Moreover, a third technology is a program for causing a computer to execute an information processing method, in which the method includes determining a processing time for performing post-processing on a depth map on the basis of a position and a posture of a device and importance level information based on a display included in the device, and performing the post-processing on the depth map for the processing time determined.

### BRIEF DESCRIPTION OF DRAWINGS

FIG. 1A is an external perspective view of an HMD 100, and

FIG. 1B is an inner view of a housing 150 of the HMD 100.

FIG. 2 is a block diagram illustrating a configuration of an HMD 100 and an information processing device 200.

FIG. 3 is an explanatory diagram of an importance level map.

FIG. 4 is a diagram illustrating a method of upsampling performed by a post-processing unit 204.

FIG. 5 is a diagram illustrating a method of filling processing performed by the post-processing unit 204.

FIG. 6 is a flowchart illustrating processing in the HMD 100 and the information processing device 200.

FIG. 7A is an explanatory diagram of a change in a self-position and a posture of the HMD 100, and FIG. 7B is an explanatory diagram of a shift of a depth map.

FIG. 8 is an explanatory diagram illustrating application of an importance level map to a depth map and assignment of processing time to the depth map.

FIG. 9 is an explanatory diagram of estimation of a self-position and posture of the HMD 100.

FIG. 10 is an explanatory diagram in a case where divided areas of the shifted depth map and the importance level map do not match.

FIG. 11 is a flowchart illustrating processing of adjusting a total processing time on the basis of a remaining battery level.

FIG. 12 is a flowchart illustrating processing of adjusting the total processing time on the basis of an operation mode of the HMD 100.

FIG. 13 is a flowchart illustrating processing of an example of adding an importance level of a detection area to an importance level map.

FIG. 14 is an explanatory diagram of allocation of processing time to a depth map based on the importance level of a detection area.

FIG. 15 is an explanatory diagram of an importance level map for each gaze area of a line of sight.

FIG. 16 is a flowchart illustrating processing in the information processing device 200 and the HMD 100 including processing of selecting an importance level map on the basis of a gaze area of a line of sight.

FIG. 17 is a block diagram illustrating configurations of the HMD 100 and the information processing device 200 in a modification in which the present technology is applied to depth map generation.

FIG. 18 is a flowchart of a modification in which the present technology is applied to depth map generation.

### MODE FOR CARRYING OUT THE INVENTION

An embodiment of the present technology is hereinafter described with reference to the drawings. Note that, the description will be given in the following order.

### 1. Embodiment

[1-1. Configuration of HMD 100 and Information Processing Device 200]
[1-2. Processing in HMD 100 and information processing device 200]
[1-3. Another example of method for adjusting total processing time]
[1-4. Example of adding importance level of detection area to importance level map]

### 2. Modifications

### 1. Embodiment

[1-1. Configuration of HMD 100 and information processing device 200]

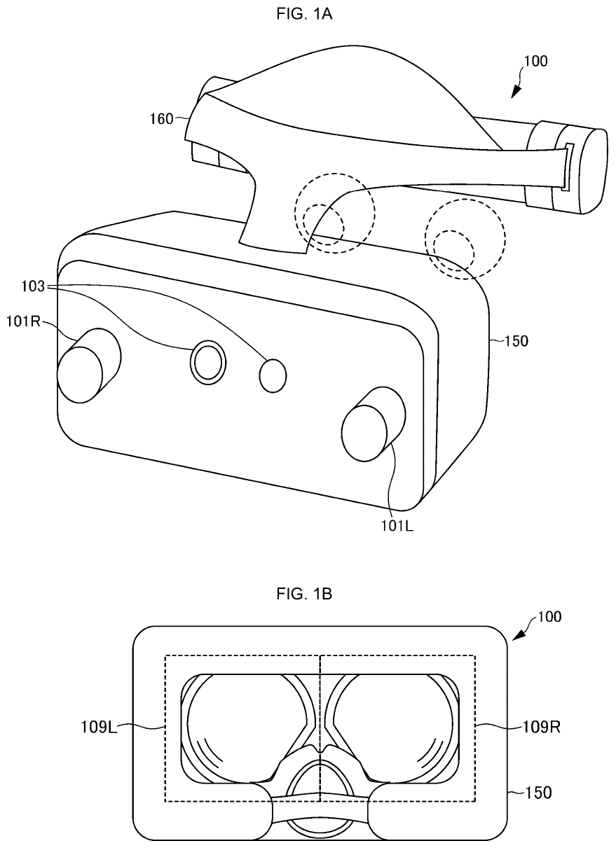

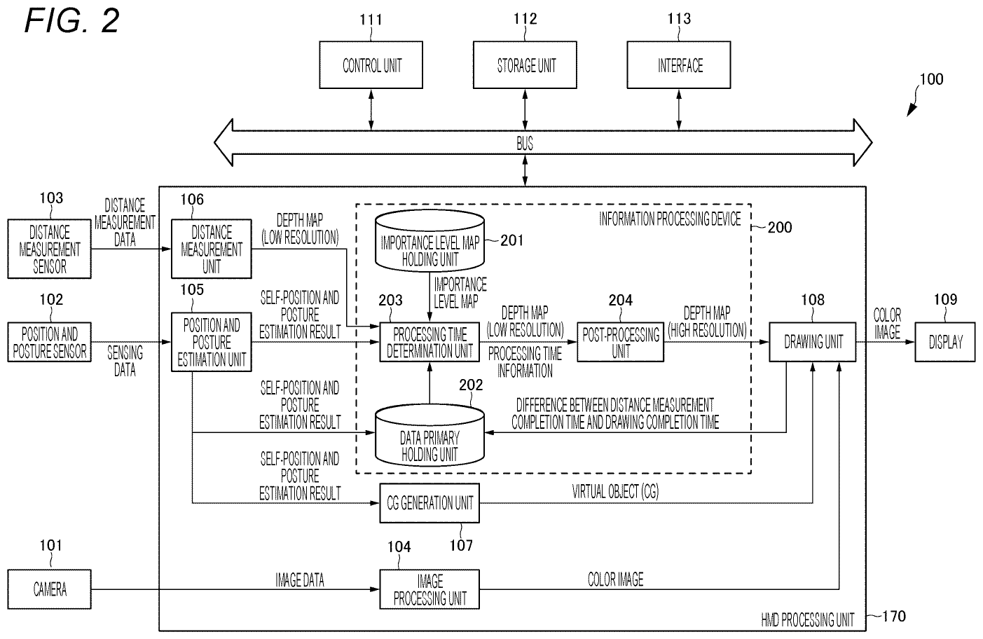

A configuration of an HMD 100 having the VST function will be described with reference to FIGS. 1 and 2. The HMD 100 includes a camera 101, a position and posture sensor 102, a distance measurement sensor 103, an image processing unit 104, a position and posture estimation unit 105, a distance measurement unit 106, a CG generation unit 107, a drawing unit 108, a display 109, a control unit 111, a storage unit 112, an interface 113, and an information processing device 200. The HMD 100 corresponds to a device in the claims.

The HMD 100 is an XR HMD worn by the user. As illustrated in FIG. 1, the HMD 100 includes a housing 150 and a band 160. The housing 150 houses the display 109, a circuit board, a processor, a battery, an input/output port, and the like. Furthermore, the camera 101 and the distance measurement sensor 103 are provided in front of the housing 150.

The camera 101 includes an image sensor, a signal processing circuit, and the like, and is a camera capable of capturing a color image and a color video of red, green, blue (RGB) or a single color. The camera 101 includes a left camera 101L that captures a color image to be displayed on a left display 109L, and a right camera 101R that captures a color image to be displayed on a right display 109R. The left camera 101L and the right camera 101R are provided outside the housing 150 toward a direction of a user's line-of-sight, and capture the outside world in the direction of the user's line-of-sight. In the following description, the left camera 101L and the right camera 101R will be simply referred to as the camera in a case where it is not necessary to distinguish the left camera 101L and the right camera 101R from each other.

The position and posture sensor 102 is various sensors that detect sensing data for estimating the position, attitude, inclination, and the like of the HMD 100. The position and posture sensor 102 outputs sensing data to the position and posture estimation unit 105. The position and posture sensor 102 is, for example, a global positioning system (GPS), an inertial measurement unit (IMU), an ultrasonic sensor, or an inertial sensor (acceleration sensor, angular speed sensor, or gyro sensor for two or three axial directions) for improving estimation accuracy or reducing system delay. A plurality of sensors may be used in combination as the position and posture sensor 102.

The distance measurement sensor 103 is a sensor that measures a distance to a subject. The distance measurement sensor 103 outputs distance measurement data, which is a sensing result, to the distance measurement unit 106. The distance measurement sensor 103 may be an infrared sensor, an ultrasonic sensor, a color stereo camera, an infrared (IR) stereo camera, a monocular camera, or the like. Furthermore, the distance measurement sensor 103 may be triangulation or the like using one IR camera and a structured light. Note that the depth is not necessarily the depth of stereo as long as the depth information can be acquired, and may be a monocular depth using time of flight (ToF) or motion parallax, a monocular depth using an image plane phase difference, or the like. A plurality of sensors may be used in combination as the distance measurement sensor 103.

The image processing unit 104 performs predetermined image processing such as analog/digital (A/D) conversion, color correction processing, gamma correction processing, Y/C conversion processing, and auto exposure (AE) processing on the image data supplied from the camera 101 to generate a color image for display, and outputs the color image to the drawing unit 108. The image processing described here is merely an example, and it is not necessary to perform all of them, and other processing may be further performed.

The position and posture estimation unit 105 estimates the position and posture of the HMD 100 on the basis of the sensing data supplied from the position and posture sensor 102. By estimating the position and posture of the HMD 100 by the position and posture estimation unit 105, the position and posture of the head of the user wearing the HMD 100 can also be estimated. Note that the position and posture estimation unit 105 can also estimate the movement, inclination, and the like of the HMD 100. In the following description, the position and posture of the HMD 100 may be referred to as a self-position and posture. The estimation result of the self-position and posture is compared with the estimation result in the next processing, and is stored in a data primary holding unit 202 for the purpose of calculating a difference.

Furthermore, the position and posture estimation unit 105 may create a map around the HMD 100 using simultaneous localization and mapping (SLAM). Such processing is often performed by a general central processing unit (CPU) or graphics processing unit (GPU), but may be performed by a processor specialized for processing of image processing or machine learning.

The distance measurement unit 106 estimates a distance (depth data) to an object around the HMD 100 on the basis of the distance measurement data output from the distance measurement sensor 103, and generates a depth map that stores the depth data for each pixel. When the depth map is generated, the distance measurement unit 106 records a time stamp indicating a distance measurement completion time (depth map generation completion time) in the depth map. The stamp may be recorded by being attached to the depth map as metadata, or may be recorded by embedding a stamp of an unimportant portion (such as an end portion) of a portion of the depth map where the depth is recorded.

The CG generation unit 107 generates various computer graphic (CG) images such as virtual objects to be synthesized with color images for augmented reality (AR) display and the like.

The drawing unit 108 draws a virtual object generated by the CG generation unit 107 on the color image output from the image processing unit 104 to generate a color image to be displayed on the display 109. The drawing unit 108 draws in consideration of the anteroposterior relationship between the virtual object generated by the CG generation unit 107 and a real object in the color image captured by the camera 101 on the basis of the depth map output from a post-processing unit 204 of the information processing device 200. In addition, the drawing unit 108 compares the time stamp indicating the distance measurement completion time included in the depth map and a time stamp indicating a drawing completion time at the drawing completion time, calculates a difference between the distance measurement completion time and the drawing completion time, and outputs the difference to the data primary holding unit 202. Although a GPU is often used for drawing, drawing may be performed by a CPU.

The display 109 is a liquid crystal display, an organic electroluminescence (EL) display, or the like that displays the color image output from the drawing unit 108. As indicated by a broken line in FIG. 1B, the display 109 is supported so as to be positioned in front of the eyes of the user when the HMD 100 is worn inside the housing 150. The display 109 includes the left display 109L that displays a color image captured by the left camera 101L and the right display 109R that displays a color image captured by the right camera 101R. In the following description, the left display 109L and the right display 109R will be simply referred to as the display in a case where it is not necessary to distinguish the left display 109L and the right display 109R.

The control unit 111 includes a CPU, a random access memory (RAM), a read only memory (ROM), and the like. The CPU controls the entire HMD 100 and each unit by executing various processing according to a program stored in the ROM and issuing commands. Note that the information processing device 200 may be implemented in processing by the control unit 111.

The storage unit 112 is, for example, a mass storage medium such as a hard disk or a flash memory. The storage unit 112 stores various applications operating on the HMD 100, various data and various information used in the HMD 100 and the information processing device 200, and the like.

The interface 113 is an interface with an external electronic device such as a personal computer or a game machine, the Internet, or the like. The interface 113 may include a wired or wireless communication interface. Furthermore, more specifically, the wired or wireless communication interface may include cellular communication, Wi-Fi, Bluetooth (registered trademark), near field communication (NFC), Ethernet (registered trademark), high-definition multimedia interface (HDMI (registered trademark)), universal serial bus (USB) and the like.

The information processing device 200 includes an importance level map holding unit 201, the data primary holding unit 202, a processing time determination unit 203, and the post-processing unit 204.

The importance level map holding unit 201 holds in advance an importance level map indicating the importance level corresponding to a display area of the display 109. The importance level map corresponds to importance level information based on the display 109 in the claims. The importance level map may be stored in the importance level map holding unit 201 in advance at the time of manufacturing the HMD 100, or may be stored later by a user, an application company, or the like. The importance level map holding unit 201 may include the storage unit 112 or may include a nonvolatile memory or the like. The information processing device 200 may acquire the importance level map from an external device, an external server, or the like via a network.

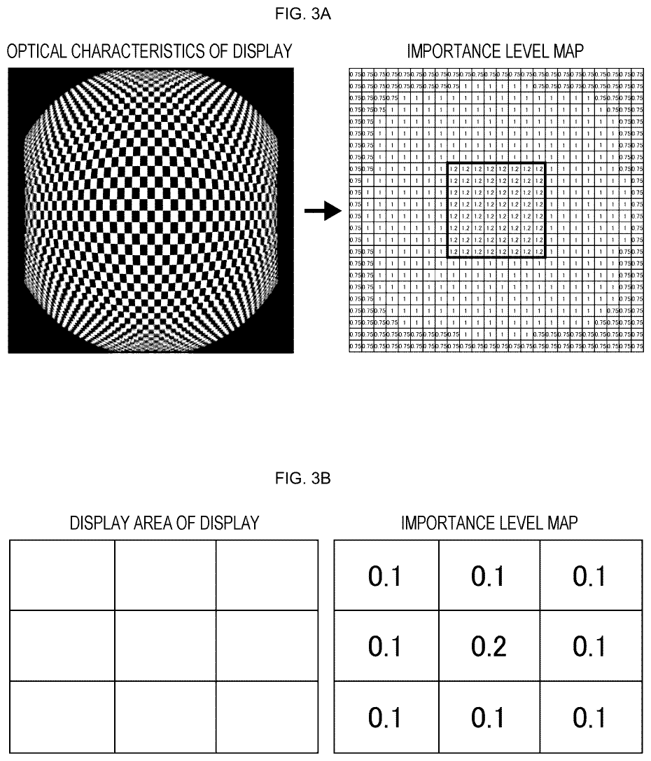

As illustrated in FIG. 3A, the importance level map is obtained by dividing the display area of the display 109 into a plurality of areas on the basis of the optical characteristics of the display 109 and associating the importance level, which is the degree of weighting, with each divided area. On the basis of the importance level in the importance level map, the processing time determination unit 203 determines the processing time of post-processing to be performed on the depth map by the post-processing unit 204.

In addition, as illustrated in FIG. 3B, the importance level map may be configured so that the display area of the display 109 is divided into a predetermined number of areas, and each divided area is associated with an importance level that is a predetermined degree of weighting of the display 109. For example, as illustrated in FIG. 3B, the display area of the display 109 is divided into nine areas of 3×3, the importance level of the central divided area is set to be high, and the importance levels of the other 8 surrounding divided areas are set to be lower than that of the central divided area. On the display 109, it is preferable to display the central area with high resolution for the reason that an object to which the user pays attention is often displayed, and thus the importance level becomes high. On the other hand, an area other than the central area is often displayed with a lower resolution than the central area due to a reason that an object of interest to the user is less often displayed, and thus the importance level is lower than that of the central area. Note that, although the display area of the display 109 is divided into nine areas of 3×3 in FIG. 3B, this is merely an example and other division numbers such as 16 divisions may be used, and the present technology is not limited to any of the division numbers.

The present embodiment will be described on the assumption that the angle of view of the display 109, the sensing range (the size of the depth map) of the distance measurement sensor 103, and the size of the importance level map are the same or substantially the same. However, the sizes of the angle of view, the depth map, and the importance level map of the display 109 are not necessarily the same or substantially the same, and the present technology is not limited to a case where they are the same or substantially the same. Usually, the sensing range (the size of the depth map) of the distance measurement sensor 103 may be slightly larger than that of the display 109. This is because the depth map is shifted in accordance with the change in the self-position and posture of the HMD 100, and the importance level map is applied to the depth map, so that an area with a depth of 0 does not occur.

The data primary holding unit 202 temporarily holds a history of self-position and posture estimation results by the position and posture estimation unit 105. The estimation result of the self-position and posture is used to calculate a difference between the past and current estimation results and to calculate a change speed of the self-position and posture. Furthermore, the data primary holding unit 202 holds information of a difference (elapsed time) from the distance measurement completion time to the drawing completion time calculated by the drawing unit 108. The data primary holding unit 202 may include the storage unit 112 or may include a nonvolatile memory or the like. In addition, the data primary holding unit 202 acquires and holds information of a difference (elapsed time) from the distance measurement completion time by the distance measurement sensor 103 to the time of display on the display 109 from the time measurement function or the like included in the HMD 100.

The processing time determination unit 203 determines a processing time for the post-processing unit 204 to perform post-processing to the depth map on the basis of the importance level map read from the importance level map holding unit 201. By applying the importance level map to the depth map, the processing time determination unit 203 divides the depth map in accordance with the divided area in the importance level map and associates the importance level of the importance level map with each divided area of the depth map. Then, by allocating a preset total processing time to each divided area of the depth map on the basis of the importance level, the post-processing unit 204 determines a processing time for performing post-processing on the depth map. As will be described in detail later, the total processing time allocated to each divided area of the depth map is determined in advance, and this is referred to as a total processing time in the following description.

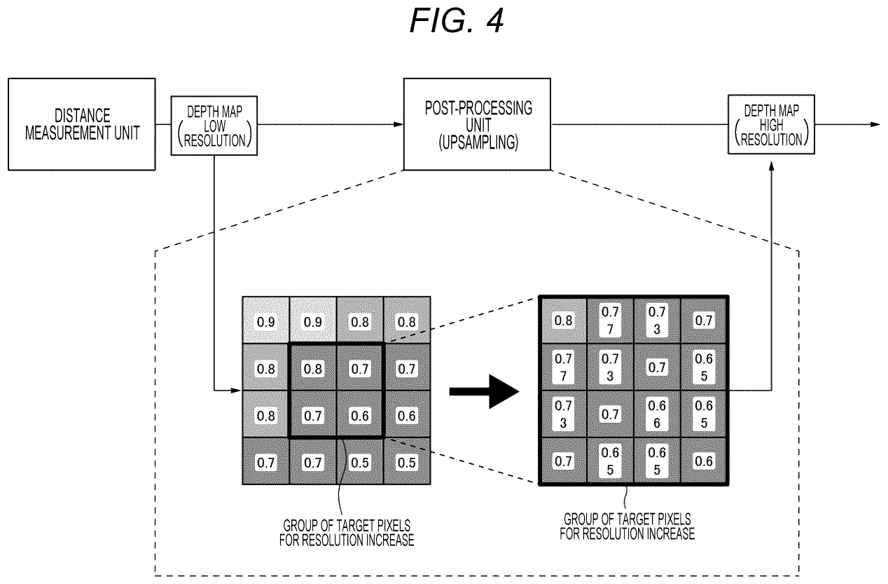

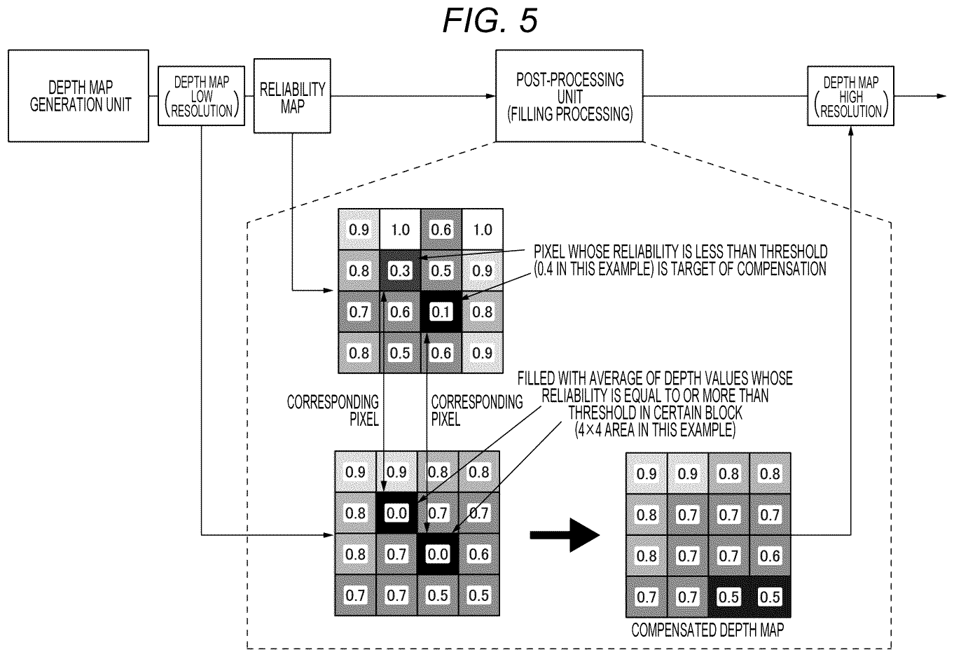

The post-processing unit 204 performs post-processing on the depth map on the basis of the processing time for each divided area of the depth map determined by the processing time determination unit 203, and outputs the depth map to the drawing unit 108. As the post-processing, there are upsampling and filling processing for making the depth map higher in resolution (higher in density) than the state generated by the distance measurement unit 106. The upsampling can be performed using a known method, for example, a method using pixels around a pixel to be upsampled as illustrated in FIG. 4. The filling processing can be performed by a known method, for example, a method using pixels around a pixel to be filled as illustrated in FIG. 5.

The upsampling and the filling processing may be performed in the same algorithm, or may be sequentially performed. The upsampling and the filling processing usually have the same processing content for each pixel, and thus the processing time is proportional only to the resolution of the depth map. The post-processing unit 204 may perform both the upsampling and the filling processing, or may perform only one of the upsampling and the filling processing, or may perform other processing in addition to or instead of the upsampling and the filling processing. This processing is often performed by a GPU, but may be performed by a CPU. Note that the processing is not limited to the upsampling and the filling, and the post-processing unit 204 may perform any processing as long as the processing increases the resolution of the depth map.

The information processing device 200 may operate in the HMD 100, may operate in an external electronic device such as a personal computer, a game machine, a tablet terminal, or a smartphone connected to the HMD 100, or may be configured as a single device connected to the HMD 100. Furthermore, the information processing device 200 and the information processing method in the information processing device 200 may be implemented by executing a program in the HMD 100 or an external electronic device having a function as a computer. In a case where the information processing device 200 is implemented by the program, the program may be installed in the HMD 100 or the electronic device in advance, or may be distributed by download, a storage medium, or the like and installed by the user himself/herself.

The above configuration does not need to be completed in the HMD 100, and for example, an HMD processing unit 170 including the image processing unit 104, the position and posture estimation unit 105, the CG generation unit 107, the drawing unit 108, and the information processing device 200 may be operated in an external electronic device such as a personal computer, a game machine, a tablet terminal, or a smartphone connected to the HMD 100. In a case where the HMD processing unit 170 operates in an external electronic device, a color image captured by the camera 101, sensor information acquired by the distance measurement sensor 103, and sensor information acquired by the position and posture sensor 102 are transmitted to the external electronic device via the interface 113 and a network (regardless of wired or wireless). Furthermore, the output from the drawing unit 108 is transmitted to the HMD 100 via the interface 113 and the network and displayed on the display 109.

Furthermore, the camera 101, the position and posture sensor 102, and the distance measurement sensor 103 need not be included in the HMD 100, and the camera 101, the position and posture sensor 102, and the distance measurement sensor 103 of a device different from the HMD 100 may be connected to the HMD 100.

Furthermore, the HMD 100 may be configured as a wearable device such as a glasses-type without the band 160, or may be configured integrally with a headphone or an earphone.

Furthermore, the HMD 100 may be configured to support not only an integrated HMD but also an electronic device such as a smartphone or a tablet terminal by fitting the electronic device into a band-shaped attachment or the like.

[1-2. Processing in HMD 100 and information processing device 200]

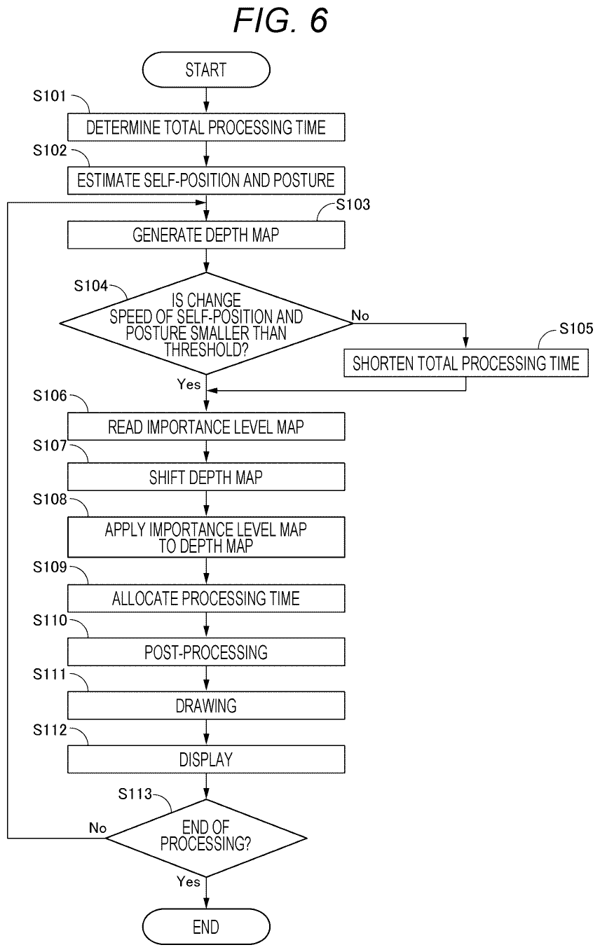

Next, processing in the HMD 100 and the information processing device 200 will be described with reference to FIG. 6.

The camera 101, the position and posture sensor 102, and the distance measurement sensor 103 are controlled by a predetermined synchronization signal, perform image capturing and sensing at a frequency of, for example, about 60 times/second or 120 times/second, and output a color image, distance measurement data, and sensing data. Then, the following processing is executed for each image output (this unit is referred to as a frame).

First, in step S101, the processing time determination unit 203 determines a total processing time that is a time for the post-processing unit 204 to perform post-processing on the depth map per frame on the basis of a predetermined algorithm or the like.

The total processing time can be determined, for example, by setting the total processing time to be the same as the time required for the processing of the drawing 1 frame by the drawing unit 108. For example, in a case where drawing by the drawing unit 108 is 90 frames per second (fps), the time required for processing one frame of drawing is about 11 milliseconds, and thus the total processing time is also set to 11 milliseconds. Note that the processing time determination unit 203 may read a predetermined total processing time from an external device, an external server, or the like via a network. In the present embodiment, the description will be given assuming that the total processing time is 11 milliseconds.

Next, in step S102, the position and posture estimation unit 105 estimates the self-position and posture of the HMD 100 on the basis of the sensing data. The position and posture estimation unit 105 outputs the estimation result of the self-position and posture to the CG generation unit 107, the data primary holding unit 202, and the processing time determination unit 203.

Next, in step S103, a depth map that stores distance data to an object around the HMD 100 for each pixel is generated on the basis of the distance measurement data acquired by the distance measurement unit 106 from the distance measurement sensor 103. The distance measurement unit 106 outputs the depth map to the processing time determination unit 203.

Next, in step S104, the processing time determination unit 203 calculates a change speed of the self-position and posture from the latest self-position and posture estimation result by the position and posture estimation unit 105 and the previous self-position and posture estimation result stored in the data primary holding unit 202, and determines whether or not the change speed of the self-position and posture is smaller than a predetermined threshold. In a case where the change speed of the self-position and posture is larger than the threshold, the processing proceeds to step S105 (No in step S104). On the other hand, in a case where the change speed of the self-position and posture is smaller than the threshold, the processing proceeds to step S106 (Yes in step S104).

In step S105, the processing time determination unit 203 adjusts the total processing time. In a case where the change speed of the self-position and posture is larger than the threshold, the processing time determination unit 203 shortens the total processing time in proportion to the amount by which the change speed exceeds the threshold. In general, it is known that the spatial resolution perceivable by a human is lowered in a case where the change speed of the self-position and posture is large, and thus the total processing time is adjusted according to the change speed of the self-position and posture. Note that, in a case where the change speed of the self-position and posture is smaller than the threshold, the total processing time is not adjusted and remains at the default value. Here, the description will be given assuming that the total processing time is 11 milliseconds as described above.

Next, in step S106, the processing time determination unit 203 reads the importance level map from the importance level map holding unit 201. However, the processing time determination unit 203 may read the importance level map from the importance level map holding unit 201 at any time before applying the importance level map to the depth map.

Next, in step S107, the processing time determination unit 203 reads, from the data primary holding unit 202, the history of the elapsed time from a past distance measurement completion time to the time of display on the display 109 (or from the distance measurement completion time to the drawing completion time) and the history of the self-position and posture estimation result during that time, and calculates the time of display of the current frame and the estimated self-position and posture at the time of display of the current frame from the history of the elapsed time and the history of the self-position and posture estimation result. Then, the depth map is shifted based on the estimated self-position and posture at the time of display of the current frame.

Next, in step S108, the processing time determination unit 203 applies the importance level map to the shifted depth map.

Next, in step S109, the processing time determination unit 203 allocates the processing time to each divided area of the depth map on the basis of the importance level map.

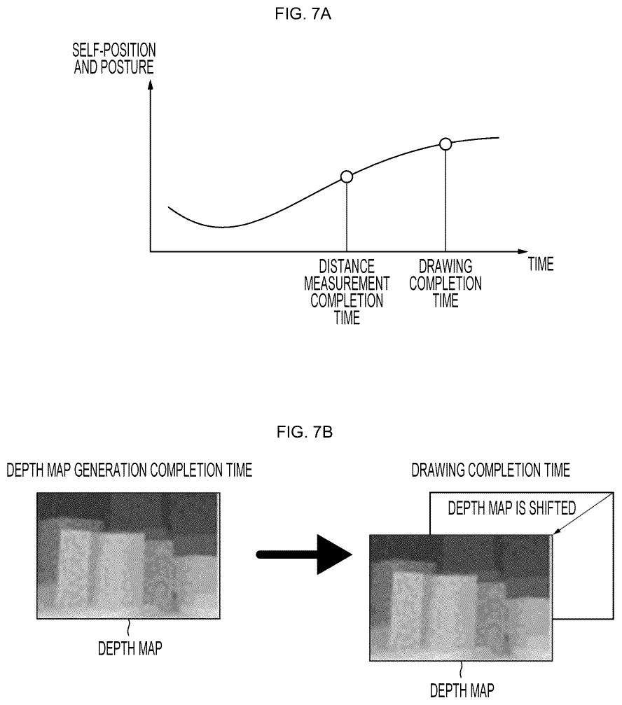

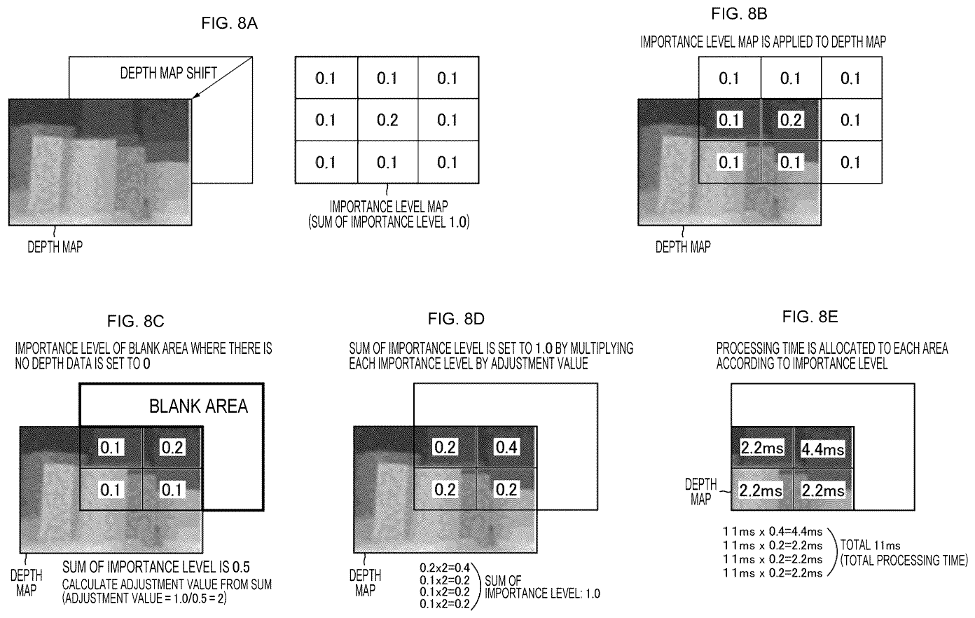

Here, the shift of the depth map in step S107, the application of the importance level map in step S108, and the allocation of the processing time in step S109 will be described with reference to FIGS. 7 and 8.

The processing time determination unit 203 can obtain a change in the self-position and posture with the lapse of time as illustrated in FIG. 7A from the difference between the distance measurement completion time and the drawing completion time read from the data primary holding unit 202, the history of the elapsed time, and the history of the self-position and posture estimation result. Then, the self-position and posture at the distance measurement completion time and at the drawing completion time can be estimated from the change in the self-position and posture. Then, the depth map is shifted as illustrated in FIG. 7B on the basis of the estimated self-position and posture of the HMD 100 at the drawing completion time. The shift amount corresponds to the change amount of the self-position and posture. In addition, the shift direction corresponds to the direction of change in the self-position and posture.

The shift amount of the depth map can be calculated from the predicted self-position and posture at the time of display as follows. In a case where the distance measurement completion time, that is, the time of post-processing is tPostProcess, an expression for converting the attitude of the position and posture sensor 102 that has acquired sensing data for estimating the self-position and posture at the time of tPostProcess into the position and posture of the distance measurement sensor 103 and converting the position and posture into a two-dimensional screen coordinate system can be written as follows.

### [Expression 1]

Pworld is the position and posture of a certain point in the world coordinate system, and vio [tPostProcess] RTworld is a transformation matrix representing a self-position and posture estimation sensor coordinate system of tPostProcess at a certain point in the world coordinate system. Pworld is converted into Pclip, that is, a point in a clip coordinate system, and the point is finally converted into a point Pscreen in the screen coordinate system. Pscreen is represented by points x and y in the screen coordinate system. Self-position and posture estimation sensor coordinates at the time of tDisplay are obtained from the data primary holding unit 202, and thus screen coordinates x and y of the distance measurement sensor 102 of tDisplay can be similarly obtained. The shift amount of the depth map can be determined on the basis of the difference between the tPostProcess and the Pscreen of the tDisplay.

Then, the importance level map is applied to the shifted depth map. Here, as illustrated in FIG. 8A, in the importance level map, similarly to FIG. 3B, the display area of the display 109 is divided into nine divided areas of 3×3, the importance level of a central divided area is set to 0.2, which is higher than that of other divided areas, so that the sum of the importance levels is 1.0, and the importance levels of the other divided areas are set to 0.1, which is lower than that of the central divided area.

The application of the importance level map to the depth map is performed by superimposing the importance level map on the shifted depth map at the position before the shift of the depth map as illustrated in FIG. 8B. Thus, the importance level in the importance level map is made to correspond to the depth map. By applying the importance level map to the depth map, the divided area of the importance level map is also applied to the depth map, and the importance level is allocated to each divided area of the depth map.

In a case where the depth map and the viewing angle of the display 109 are substantially the same size, or in a case where the depth map does not cover a wider viewing angle than the display 109, when the depth map is shifted as illustrated in FIG. 8A and then the importance level map is applied to the depth map as illustrated in FIG. 8B, a blank area in which depth data does not exist, such as an area surrounded by a thick line illustrated in FIG. 8C, occurs. Since a blank area having no depth data is not a post-processing target even if the importance level map is applied, the importance level of the blank area is set to 0.

In the state illustrated in FIG. 8C as a result of applying the importance level map to the depth map, the importance level in the divided areas where the depth data exists in the depth map are 0.2, 0.1, 0.1, and 0.1, and the sum of the importance levels of the importance level maps is 0.5.

Then, an adjustment value is calculated by the following Expression 2. The adjustment value is a value for leveling the sum of the importance levels of the respective divided areas of the depth map obtained by applying the importance level map to the sum of the importance levels in the importance level map.

### [Expression 2]

Sum of importance levels in importance level map/sum of importance levels of respective divided areas of depth map by application of importance level map

In FIG. 8, the sum of the importance levels in the importance level map is 1.0, and the sum of the importance levels of the respective divided areas of the depth map obtained by applying the importance level map is 0.5, so that the adjustment value is 2.

Then, as illustrated in FIG. 8D, the sum of the importance levels is leveled to 1.0 by multiplying each importance level in the importance level map by the adjustment value. In FIG. 8D, the importance levels of the respective divided areas of the depth map are 0.4, 0.2, 0.2, and 0.2 by the adjustment values, and the sum of the importance levels is 1.0.

Then, as illustrated in FIG. 8E, the total processing time is allocated to each divided area of the depth map on the basis of the importance level. Since the divided area having the importance level of 0.4 has a higher importance level than other divided areas, the longest processing time (4.4 milliseconds) is allocated. Since the divided area having the importance level of 0.2 has a low importance level, a short processing time (2.2 milliseconds) is allocated. The total processing time allocated to each divided area is 11 milliseconds, which is the same as the total processing time.

As described above, in the present technology, the processing time allocated to an unimportant area of the depth map is shortened, and the processing time allocated to an important area of the depth map is lengthened accordingly. Thus, the sum of the processing times of the respective divided areas does not exceed the total processing time.

Note that, in a case where the depth map covers a wider viewing angle than the display 109, the importance level map is applied as it is. The importance level map can be applied to the entire depth map.

When the post-processing unit 204 performs post-processing, the processing time determination unit 203 records, in the depth map, a time stamp indicating the predicted time at which the color image is displayed on the display 109, in addition to the time stamp indicating the distance measurement completion time.

The description returns to the flowchart of FIG. 6. Next, in step S110, the post-processing unit 204 performs post-processing on the depth map according to the processing time in each divided area determined by the processing time determination unit 203. Thus, in the example of FIG. 8, the post-processing on the divided area to which the processing time of 4.4 milliseconds is allocated in the depth map is performed in 4.4 milliseconds, and the post-processing on the divided area to which the processing time of 2.2 milliseconds is allocated is performed in 2.2 milliseconds.

The upsampling and filling processing are performed as the post-processing, but it is not always necessary to perform both, and either one of them may be performed. Since the processing amount per pixel is often constant in these processes, it is easy to plan the processing completion time. The post-processing unit 204 outputs the depth map that has been post-processed to the drawing unit 108.

Next, in step S111, the drawing unit 108 performs processing of drawing a virtual object on the color image in consideration of shielding on the basis of the depth map processed by the post-processing unit 204. At the time of drawing, the drawing unit 108 refers to a time stamp indicating a predictive display time predicted by the processing time determination unit 203 and recorded in the depth map, calculates the self-position and posture of the HMD 100 at the predictive display time, and performs drawing. The distance measurement completion time coincides with the drawing completion time, and it is possible to perform shielding without deviation by the virtual object to be drawn. The drawing unit 108 outputs the color image subjected to the drawing processing to the display 109. Note that when the self-position and posture changes, the visual field of the user in the HMD 100 also changes. For example, when the user moves the head wearing the HMD 100 to the right, the field of view of the user moves to the left. Drawing is performed in consideration of such a change.

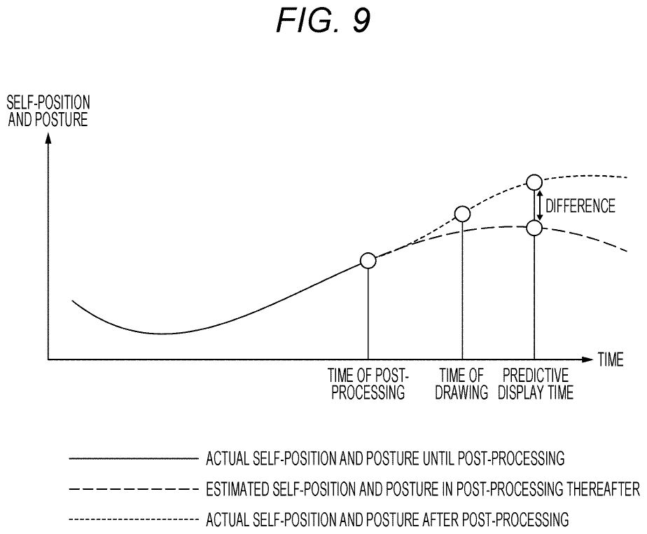

At the drawing completion time, the self-position and posture of the HMD 100 at the time of display can be predicted more accurately than at the time of post-processing, but if the depth map and the drawing result are processed on the basis of different self-position and postures, a deviation occurs in the shielding result. As illustrated in FIG. 9, a difference occurs between the self-position and posture at the predictive display time of the HMD 100 predicted at the time of post-processing and the self-position and posture at the predictive display time of the HMD 100 that can be predicted at the drawing completion time or immediately before the time of display and are more accurate, but the difference is approximated by image deformation using the self-position and posture predicted at the time of the drawing result. This is commonly referred to as Timewarp or Temporal reprojection. The drawing unit 108 records a time stamp indicating the timing of the drawing completion in the data primary holding unit 202 at the drawing completion time.

Next, in step S112, the color image subjected to the drawing processing is displayed on the display 109. Thus, the user wearing the HMD 100 can view the color image in which the virtual object is drawn.

Then, it is determined in step S113 whether or not the processing has been completed, and in a case where the processing has not been completed, the process proceeds to step S103, and steps S103 to S113 are repeated until the processing is completed (No in step S112). Whether or not the processing has ended can be determined by, for example, whether or not the user has ended the use of the HMD 100 (turned off the HMD 100, terminated the application operating on the HMD 100, or the like).

The processing by the information processing device 200 is performed as described above. According to the present technology, it is possible to increase the processing time allocated to the important area of the depth map without exceeding the predetermined total processing time. In addition, it is possible to shorten the processing time allocated to an unimportant area of the depth map. Thus, since post-processing can be performed over a long processing time in an important area of the depth map, resolution of the important area can be increased as compared with that of the unimportant area.

In addition, since the processing time is allocated to the divided area of the depth map within the preset total processing time, the processing time for the depth map as a whole is not increased and the processing is not delayed. Since the processing is not delayed, it is possible to reduce a difference between the timing of generating the depth map and the timing of drawing the color image and the timing of displaying the color image. In addition, the problem that the same processing time as that of the important area is allocated to the non-important area can also be solved.

Note that, for convenience of explanation, FIG. 8 illustrates a state in which the edge of the shifted depth map matches the divided areas of the importance level map. However, since the shift amount of the depth map is based on the change amount of the self-position and posture, the edge of the depth map does not necessarily coincide with the divided areas of the importance level map.

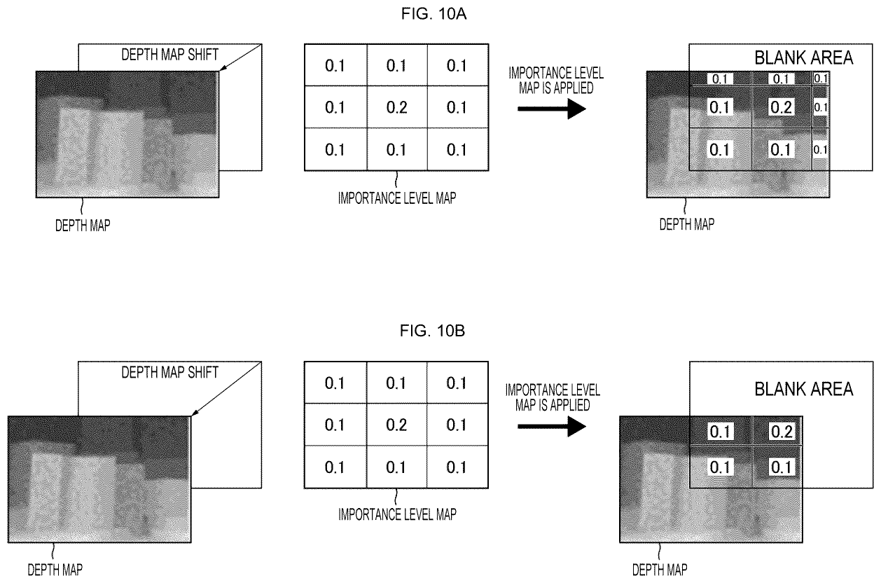

For example, as illustrated in FIGS. 10A and 10B, as a result of shifting the depth map, in a case where the edge of the depth map does not match the edges of the divided areas of the importance level map, the importance level of the importance level map is associated with the divided areas regardless of the size of the divided areas of the depth map, and then the processing time is allocated to the divided areas.

### [1-3. Another Example of Method for Adjusting Total Processing Time]

Next, another example of a method of adjusting the total processing time by the processing time determination unit 203 will be described. In the above-described embodiment, it has been described that the total processing time is shortened on the basis of the change speed of the self-position and posture in step S105 of the flowchart of FIG. 6, but the processing time determination unit 203 may adjust the total processing time on the basis of other conditions.

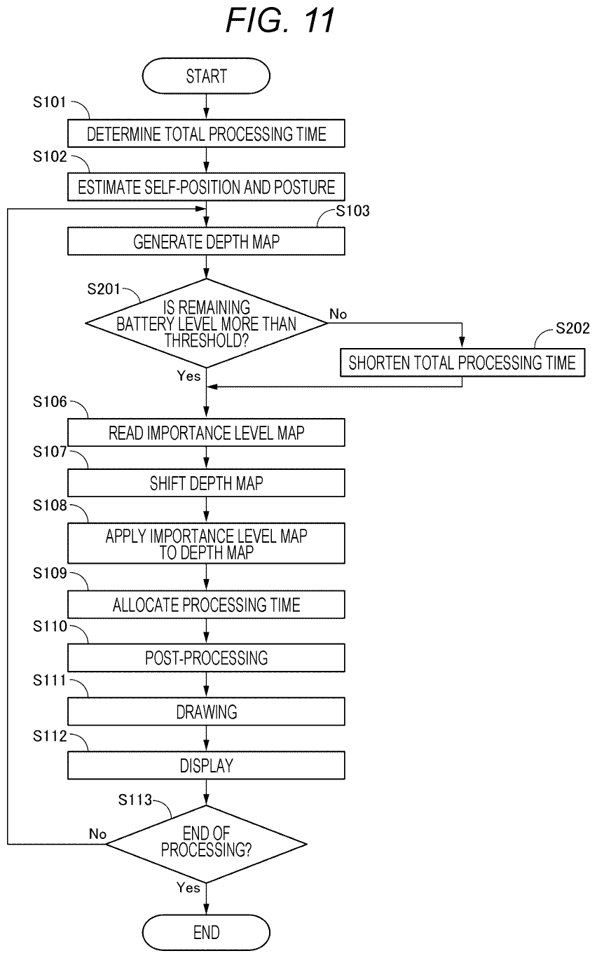

FIG. 11 is a flowchart in a case where the total processing time is adjusted on the basis of the remaining battery level of the HMD 100. The embodiment is similar to the embodiment illustrated in FIG. 6 except for steps S201 and S202. As illustrated in step S201, in a case where the remaining battery level of the HMD 100 is less than the predetermined threshold (No in step S201), the total processing time is shortened in step S202.

In addition, a total processing time (for example, three types of long, medium, and short) of a plurality of lengths is prepared in advance, and further, a threshold corresponding to each type of the total processing time is set. Then, the total processing time may be set to the longest total processing time by default, and in a case where the remaining battery level of the HMD 100 is equal to or less than any threshold, the total processing time may be changed to the total processing time corresponding to the threshold. Thus, in a case where the remaining battery level is small, the total processing time is shortened, so that the consumption of the battery due to the processing of the post-processing unit 204 can be suppressed.

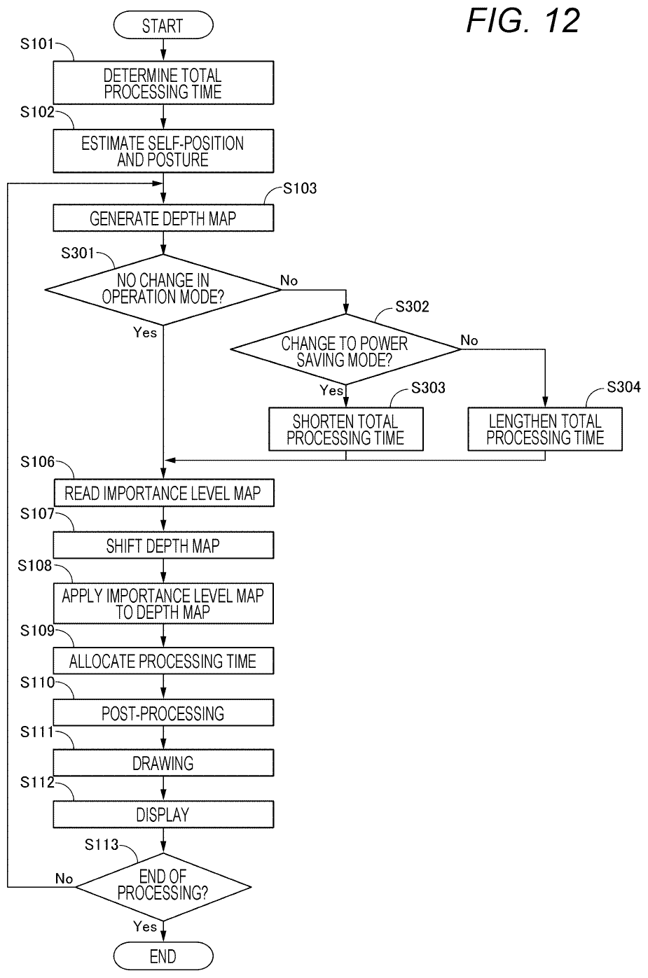

Furthermore, the total processing time can be adjusted according to the operation mode of the HMD 100. FIG. 12 is a flowchart in a case where the total processing time is adjusted on the basis of the operation mode of the HMD 100. The embodiment is similar to the embodiment illustrated in FIG. 6 except for steps S301 to S304.

For example, in a case where the HMD 100 has three operation modes of full power, standard, and power saving, the processing time determination unit 203 determines whether or not the operation mode of the HMD 100 has been changed as illustrated in step S301 of the flowchart of FIG. 12.

In a case where the operation mode has been changed, the process proceeds to step S302 (No in step S301), and it is determined whether or not the operation mode is changed to the power saving mode. In a case where the operation mode is changed to the power saving mode, the processing proceeds to step S303 (Yes in step S302), and the processing time determination unit 203 shortens the total processing time. On the other hand, in a case where the operation mode has not been changed to the power saving mode, which means that the operation mode has been changed to the full power mode, the processing proceeds to step S304 (No in step S302), and the processing time determination unit 203 increases the total processing time.

In a case where the HMD 100 is in the full power mode, it is not necessary to suppress power consumption, and thus it is possible to lengthen the total processing time for performing post-processing on the depth map. On the other hand, in a case where the HMD 100 is in the power saving mode, the total processing time is shortened in order to suppress the power consumption due to the processing of the post-processing unit 204.

The processing time determination unit 203 may adjust the total processing time according to the type (for example, a complex shape, a normal shape, or a simple shape) of the virtual object drawn by the drawing unit 108. The total processing time is lengthened in the case of the complicated shape, and the total processing time is shortened in the case of the simple shape.

Furthermore, in a case where a virtual object drawn by an application operating in the HMD 100 is specified in advance, the processing time determination unit 203 may determine the processing time according to the type of the virtual object. For example, an application developer, an application business operator, or the like sets “since a complicated virtual object is not drawn in this application, the application is operated in the simple shape mode to set the total processing time to be short” in the application in advance.

Note that, in a case where the drawing unit 108 does not perform the drawing processing, such as a case where there is no virtual object to be drawn, this may be notified to the processing time determination unit 203, and the processing of the processing time determination unit 203 may be stopped. This is because, in a case where the drawing unit 108 does not perform the drawing processing, it is not necessary to perform the processing time determination processing.

Furthermore, in a case where the drawing unit 108 is performing the drawing processing but there is no virtual object to be subjected to shielding processing in the visual field, the processing time determination unit 203 may be notified of the fact and the processing of the processing time determination unit 203 may be stopped. A process of not performing drawing in a case where there is no drawing target in the field of view is generally called viewport culling.

### [1-4. Example of Adding Importance Level of Detection Area to Importance Level Map]

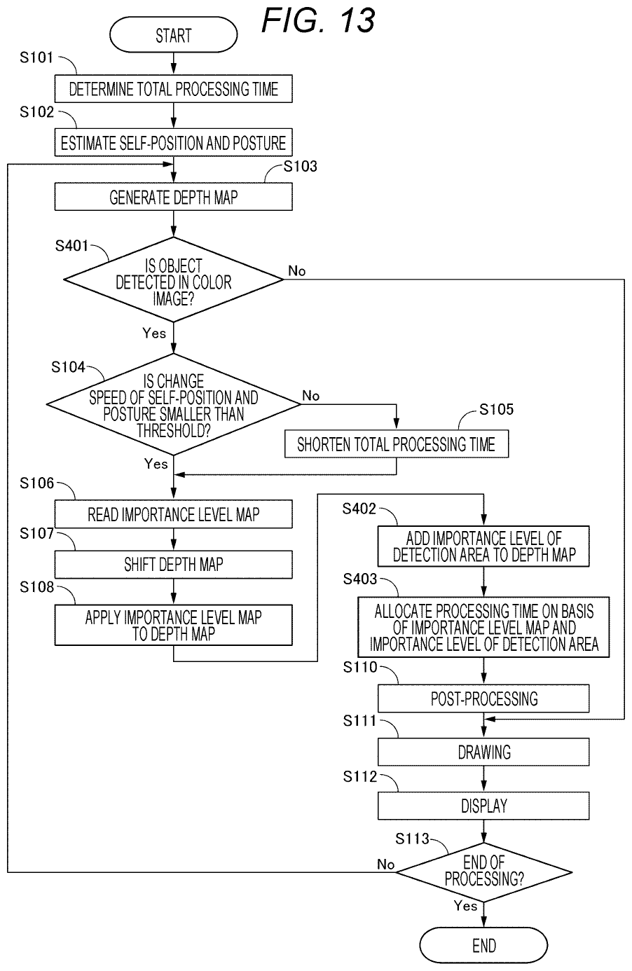

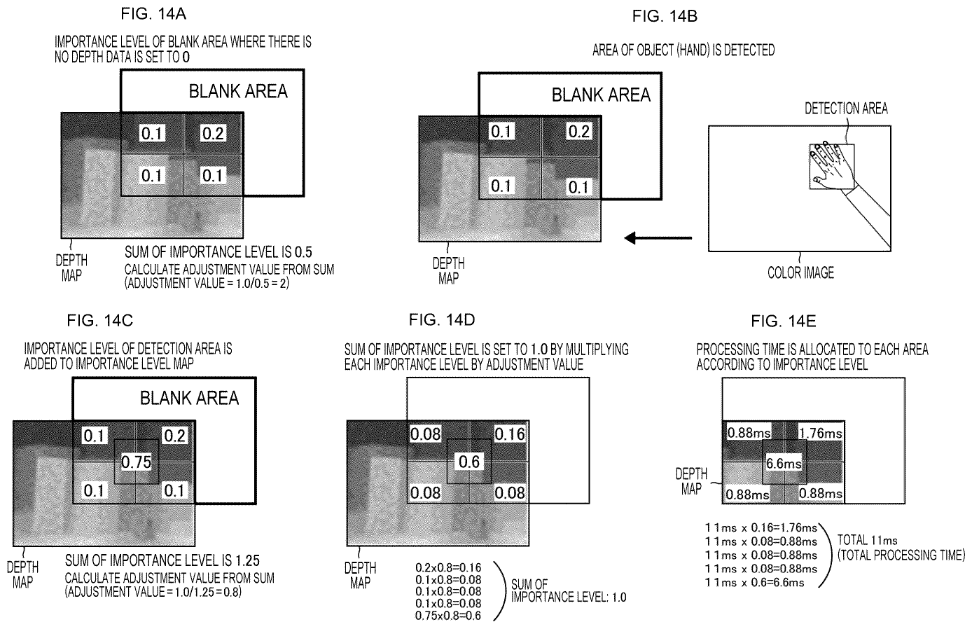

The HMD 100 may have a function of detecting an object (for example, a hand) from a color image captured by the camera 101 and displayed on the display 109. In the present technology, the area of the object detected by an object detection function can be added to the importance level map as an important area. This point will be described with reference to the flowchart of FIG. 13 and FIG. 14. Note that steps other than steps S401 to $403 of the flowchart of FIG. 13 are similar to those of the embodiment illustrated in FIG. 6.

First, as illustrated in step S401, in a case where the HMD 100 detects an object in the color image by the object detection function, the processing proceeds to step S104 (Yes in step S401). In a case where an object is not detected, the drawing processing is started without applying the importance level map to the depth map (No in step S401).

In a case where an object is detected, steps S104 to S107 are performed, and after the importance level map is applied to the depth map in step S108, the importance level of the detection area is added to the importance level map in step S402, and the importance level of the detection area is applied to the depth map.

Then, in step S403, the processing time determination unit 203 allocates the processing time to the depth map on the basis of the importance level in the importance level map and the importance level of the detection area.

Here, the allocation of the processing time to the depth map based on the importance level of the detection area will be described with reference to FIG. 14.

FIG. 14A is a state similar to FIG. 8C, the importance level map is applied to the depth map, and the importance level of the blank area having no depth data generated by the application is set to 0. Furthermore, the sum of the importance levels in the depth map is 0.5.

Assuming that an area of a hand is detected from the color image captured by the camera 101 as illustrated in FIG. 14B, the importance level of the detection area of the hand is added to the importance level map as illustrated in FIG. 14C, thereby applying the importance level of the detection area to the depth map.

In the state of FIG. 14C, the importance levels of the divided areas having depth data in the depth map are 0.2, 0.1, 0.1, and 0.1, and the importance level of the hand detection area is 0.75, and the sum of the importance levels is 1.25. Note that the importance level of the detection area of the hand is set to 0.75 only for example, and the present technology is not limited to this value. The importance level of the detection area can be determined in advance for each detection target. For example, for the detection area of the hand, the importance level is determined to be 0.5 in advance regardless of the size of the rectangular area including the hand, and 0.5 is allocated to the other areas. This is because the reach of the hand is determined when viewed from the first-person viewpoint, and thus the range of the rectangular size is roughly limited.

Then, the adjustment value is calculated by the following Expression 3. The adjustment value is a value for leveling the sum of the importance levels of respective divided areas of the depth map and the importance level of the detection area by applying the importance level map to the sum of the importance levels in the importance level map.

### [Expression 3]

Sum of importance levels in importance level map/sum of importance levels of respective divided areas of depth map and importance level of detection area by application of importance level map

In FIG. 14, the sum of the importance levels in the importance level map is 1.0, and the sum of the importance levels of respective divided areas of the depth map and the importance level of the detection area obtained by applying the importance level map is 1.25, so that the adjustment value is 0.8.

Then, as illustrated in FIG. 14D, the sum of the importance levels is leveled to 1.0 by multiplying the importance level of each divided area by the adjustment value. In FIG. 14D, the importance levels of the respective areas are 0.16, 0.08, 0.08, 0.08, and 0.6 by the adjustment values, and the sum of the importance levels is 1.0. As described above, in the present technology, not only in a case where the sum of the importance levels is smaller than 1.0, but also in a case where the sum of the importance levels is larger than 1.0, the sum of the importance levels is leveled to 1.0 with the adjustment value.

Then, as illustrated in FIG. 14E, the total processing time is allocated to each divided area of the depth map on the basis of the importance level. A processing time of 1.76 milliseconds is allocated to the divided area having the importance level of 0.16. A processing time of 0.88 milliseconds is allocated to the divided area having the importance level of 0.08. Moreover, a processing time of 6.6 milliseconds is allocated to the divided area having the importance level of 0.6. The total processing time allocated to each divided area is 11 milliseconds, which is the same as the total processing time. In this manner, the processing time can be assigned to the depth map by reflecting the detection result of the object.

In the above description, the detection area of the hand is a specific example, but the detection area is not limited to the hand. The importance level of the detection area is similarly added to the importance level map for the area of any object that can be detected by the object detection function, so that the importance level of the detection area can be applied to the depth map and the processing time can be allocated.

Furthermore, in a case where the HMD 100 has a human body detection function by a bone detection function or the like, the processing time can be allocated by applying the importance level of the detection area to the depth map by similarly adding the importance level of the detection area to the importance level map for the human area detected from the color image. In this case, the importance level of the area in the importance level map corresponding to the human area is increased.

Furthermore, in a case where the HMD 100 has a line-of-sight detection function, the processing time can be allocated by applying the importance level of the detection area to the depth map by similarly adding the importance level of a gaze area to the importance level map for the gaze area of the user's line of sight that can be detected by the line-of-sight detection function. In the line-of-sight detection function, since a point at which the line-of-sight vector intersects the drawing plane can be known, the gaze area of the line of sight can be specified accordingly. This gaze area can be added to the importance level map as an important area. In this case, the importance level of the area in the importance level map corresponding to the gaze area is increased.

Any plurality of the object detection area, the human body detection area by bone detection, and the gaze area by line-of-sight detection described above may be combined and their importance level may be added to the importance level map, or the importance level of all the detection areas may be added to the importance level map. The importance level of the detection area or the gaze area corresponds to importance level information in the claims.

### 2. Modifications

Although the embodiment of the present technology has been specifically described above, the present technology is not limited to the above-described embodiment, and various modifications based on the technical idea of the present technology are possible.

In the embodiment, the example in which the device is the HMD 100 has been described, but the present technology can be applied to a device such as a smartphone or a tablet terminal in which optical characteristics do not change between the center and the periphery of a display by defining the vicinity of the center of the display area of the display as an important area.

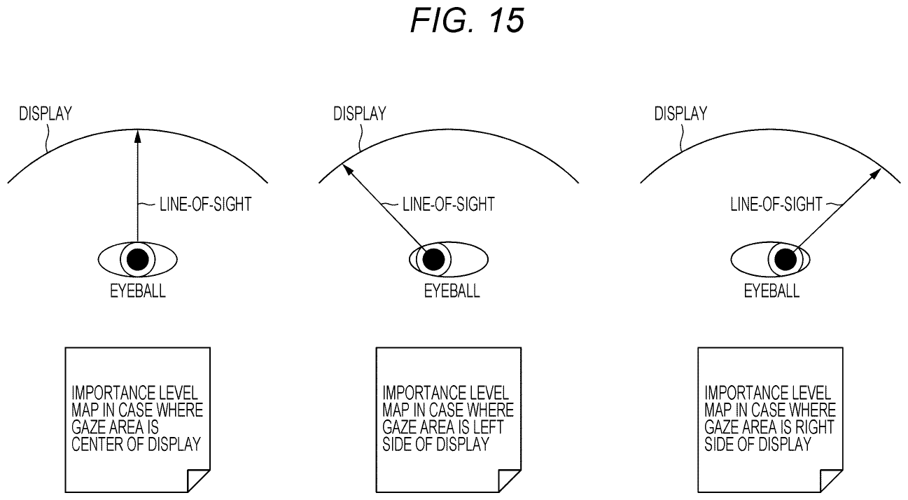

In many cases, because distortion is large in a display having a wide angle of view, how the user looks differs greatly depending on whether the gaze area of the user's line of sight is the center or the left or right end of the display. In such a case, as illustrated in FIG. 15, a plurality of importance level maps reflecting weights of optical characteristics different for each gaze area of the line of sight are prepared in advance and stored in the importance level map holding unit 201, and the importance level map to be used is selected and read on the basis of which area of the display the detected line of sight is gazing at. In FIG. 15, an importance level map in a case where the line of sight is gazing at the central area of the display, an importance level map in a case where the line of sight is gazing at the left area of the display, and an importance level map in a case where the line of sight is gazing at the right area of the display are prepared.

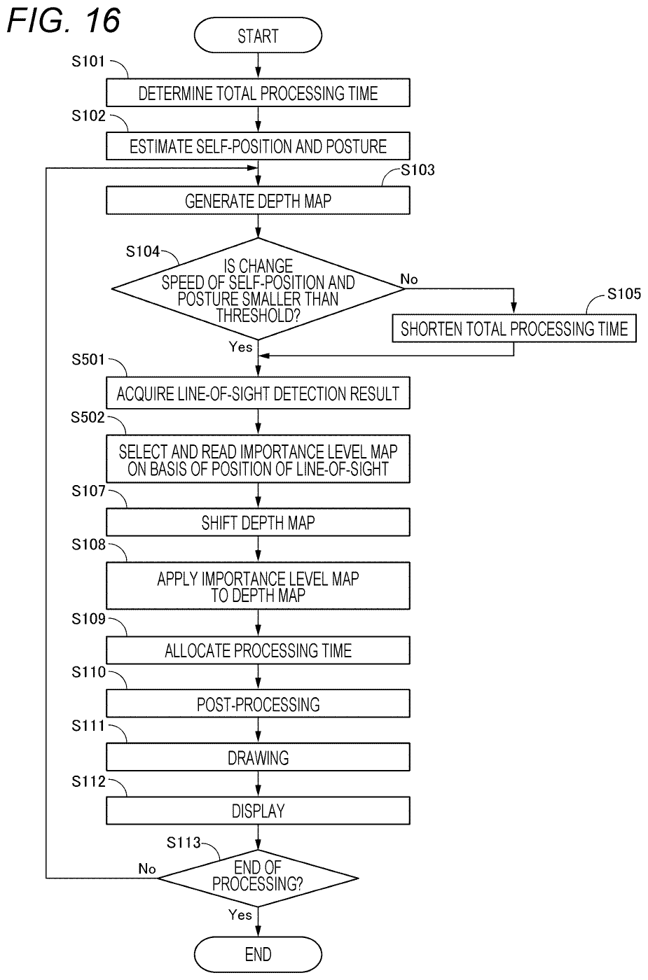

FIG. 16 is a flowchart in a case where the importance level map is selected on the basis of the gaze area of the line of sight. The embodiment is similar to the embodiment illustrated in FIG. 6 except for steps S501 and S502.

In step S501, the processing time determination unit 203 acquires a line-of-sight detection result detected by the line-of-sight detection function included in the HMD 100. Next, in step S502, the processing time determination unit 203 selects and reads an importance level map to be used from among the plurality of importance level maps on the basis of the line-of-sight detection result.

Furthermore, the present technology can also be applied to a process of generating a depth map, instead of the post-processing for the generated depth map described in the embodiment.

An image sensor included in the camera 101 normally records an image in units of frames. On the other hand, a time-of-flight (ToF) sensor or a dynamic vison sensor (DVS) does not have a concept of a frame in principle. Thus, in order to facilitate handling by the drawing unit 108, a certain period of time is set as one frame, and light received during the certain period of time is accumulated to form a depth map for one frame. Accordingly, the present technology can be applied to depth map generation by determining the number of times of sampling received light on the basis of the importance level map like upsampling.

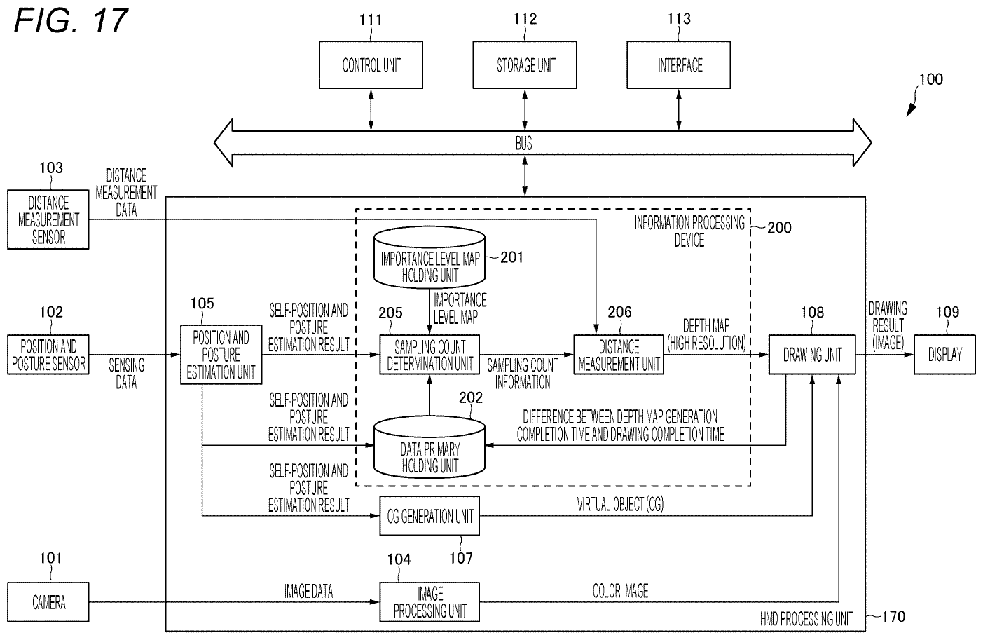

FIG. 17 is a block diagram in a case where the present technology is applied to depth map generation. In this modification, a sampling count determination unit is provided instead of the processing time determination unit 203, and information on the sampling count determined by the sampling count determination unit is output to the distance measurement unit 206 that generates the depth map.

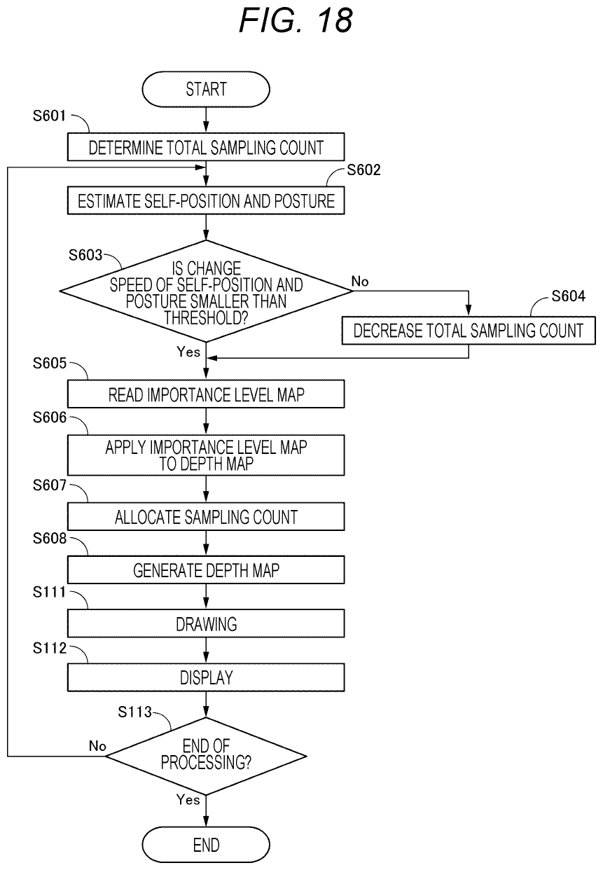

FIG. 18 is a flowchart in a case where the technology is applied to depth map generation. The embodiment is similar to the embodiment except for steps S601 to S608.

First, in step S601, the sampling count determination unit determines the total sampling count. Next, in step S602, the position and posture estimation unit 105 estimates the self-position and posture of the HMD 100 on the basis of the sensor information. Then, in step S603, the sampling count determination unit calculates the change speed of the self-position and posture from the latest self-position and posture estimation result and the previous self-position and posture estimation result stored in the data primary holding unit 202, and determines whether or not the change speed of the self-position and posture is smaller than a predetermined threshold. In a case where the change speed of the self-position and posture is larger than the threshold, the processing proceeds to step S604 (No in step S603). On the other hand, in a case where the change speed of the self-position and posture is smaller than the threshold, the processing proceeds to step S605 (Yes in step S603).

Next, in step S605, the sampling count determination unit reads the importance level map from the importance level map holding unit 201, and applies the importance level map to the sensing area of the distance measurement sensor 103 in step S606.

Next, in step S607, the sampling count determination unit determines the sampling count on the basis of the importance level of each divided area in the importance level map, and outputs sampling count information to the distance measurement unit 106. Then, the distance measurement unit 106 performs sampling with the determined number of times of sampling to generate a depth map.

The present technology can also have the following configurations.
(1)
An information processing device including:
a processing time determination unit that determines a processing time for performing post-processing on a depth map on the basis of a position and a posture of a device and importance level information based on a display included in the device; and a post-processing unit that performs the post-processing on the depth map for the processing time determined by the processing time determination unit.
(2)
The information processing device according to (1), in which the processing time determination unit determines the processing time for each of areas in the depth map by allocating a preset total processing time to the areas on the basis of the importance level information.
(3)
The information processing device according to (2), in which the processing time determination unit determines the processing time by dividing the depth map into a plurality of areas on the basis of the importance level information and dividing the total processing time into the plurality of areas and allocating the total processing time.
(4)
The information processing device according to any one of (1) to (3), in which the processing time determination unit determines the processing time by applying the importance level information to the depth map shifted on the basis of the position and posture of the device.
(5)
The information processing device according to any one of (1) to (4), in which the importance level information is an importance level map in which a display area of the display is divided into a plurality of divided areas, and importance levels are associated with the plurality of divided areas.
(6)
The information processing device according to any one of (1) to (5), in which the importance level information is an importance level map in which an importance level is associated with a display area of the display in advance on the basis of optical characteristics of the display.
(7)
The information processing device according to any one of (1) to (6), in which the importance level information is an importance level of an area of an object detected from an image displayed on the display.
(8)
The information processing device according to any one of (1) to (7), in which the importance level information is an importance level of a gaze area of a user in the display area of the display.
(9)
The information processing device according to any one of (1) to (8), in which the post-processing is processing of enhancing resolution of the depth map.
(10)
The information processing device according to (9), in which the post-processing is upsampling processing for the depth map.
(11)
The information processing device according to (9) or (10), in which the post-processing is filling processing for the depth map.
(12)
The information processing device according to (2), in which the processing time determination unit adjusts the total processing time on the basis of change speeds of past and current positions and postures of the device.
(13)
The information processing device according to (2), in which the processing time determination unit adjusts the total processing time on the basis of a remaining battery level of the device.
(14)
The information processing device according to (2), in which the processing time determination unit adjusts the total processing time according to an operation mode of the device.
(15)
The information processing device according to any one of (1) to (14), in which the post-processing unit outputs the depth map that has been post-processed to a drawing unit that draws a virtual object in an image to be displayed on the display.
(16)
The information processing device according to any one of (1) to (15), in which the device is a head mounted display.
(17)
An information processing method including:
determining a processing time for performing post-processing on a depth map on the basis of a position and a posture of a device and importance level information based on a display included in the device; and
performing the post-processing on the depth map for the processing time determined.
(18)
A program for causing a computer to execute an information processing method, in which
the method includes:
determining a processing time for performing post-processing on a depth map on the basis of a position and a posture of a device and importance level information based on a display included in the device; and
performing the post-processing on the depth map for the processing time determined.

### REFERENCE SIGNS LIST

100 Head mounted display (HMD)
200 Information processing device
203 Processing time determination unit
204 Post-processing unit

1. An information processing device comprising:
a processing time determination unit that determines a processing time for performing post-processing on a depth map on a basis of a position and a posture of a device and importance level information based on a display included in the device; and
a post-processing unit that performs the post-processing on the depth map for the processing time determined by the processing time determination unit.

2. The information processing device according to claim 1, wherein
the processing time determination unit determines the processing time for each of areas in the depth map by allocating a preset total processing time to the areas on a basis of the importance level information.

3. The information processing device according to claim 2, wherein
the processing time determination unit determines the processing time by dividing the depth map into a plurality of areas on a basis of the importance level information and dividing the total processing time into the plurality of areas and allocating the total processing time.

4. The information processing device according to claim 1, wherein
the processing time determination unit determines the processing time by applying the importance level information to the depth map shifted on a basis of the position and posture of the device.

5. The information processing device according to claim 1, wherein
the importance level information is an importance level map in which a display area of the display is divided into a plurality of divided areas, and importance levels are associated with the plurality of divided areas.

6. The information processing device according to claim 1, wherein
the importance level information is an importance level map in which an importance level is associated with a display area of the display in advance on a basis of optical characteristics of the display.

7. The information processing device according to claim 1, wherein
the importance level information is an importance level of an area of an object detected from an image displayed on the display.

8. The information processing device according to claim 1, wherein
the importance level information is an importance level of a gaze area of a user in the display area of the display.

9. The information processing device according to claim 1, wherein
the post-processing is processing of enhancing resolution of the depth map.

10. The information processing device according to claim 9, wherein
the post-processing is upsampling processing for the depth map.

11. The information processing device according to claim 9, wherein
the post-processing is filling processing for the depth map.

12. The information processing device according to claim 2, wherein
the processing time determination unit adjusts the total processing time on a basis of change speeds of past and current positions and postures of the device.

13. The information processing device according to claim 2, wherein
the processing time determination unit adjusts the total processing time on a basis of a remaining battery level of the device.

14. The information processing device according to claim 2, wherein
the processing time determination unit adjusts the total processing time according to an operation mode of the device.

15. The information processing device according to claim 1, wherein
the post-processing unit outputs the depth map that has been post-processed to a drawing unit that draws a virtual object in an image to be displayed on the display.

16. The information processing device according to claim 1, wherein
the device is a head mounted display.

17. An information processing method comprising:
determining a processing time for performing post-processing on a depth map on a basis of a position and a posture of a device and importance level information based on a display included in the device; and
performing the post-processing on the depth map for the processing time determined.

18. A program for causing a computer to execute an information processing method, wherein
the method comprises:
determining a processing time for performing post-processing on a depth map on a basis of a position and a posture of a device and importance level information based on a display included in the device; and
performing the post-processing on the depth map for the processing time determined.
